(19) United States
(12) Patent Application Publication
(10) Pub. No.: US 2012/0323521 A1
(43) Pub. Date: Dec. 20, 2012

(54) SYSTEM AND METHOD FOR RECOGNIZING GESTURES

(75) Inventors: Etienne De Foras, Saint Nazaire Les Eymes (FR); Yanis Caritu, Saint Joseph De Riviere (FR); Nathalie Sprynski, Caissargues (FR); Christelle Godin, Brignoud (FR); Sylvie Charbonnier, Echirolles (FR)

(73) Assignees: COMMISSARIAT A L'ENERGIE ATOMIQUE ET AUX ENERGIES AL TERNATIVES, Paris (FR); MOVEA, Grenoble (FR)

(21) Appl. No.: 13/499,175

(22) PCT Filed: Sep. 29, 2010
(86) PCT No.: PCT/EP2010/064501

§ 371 Date: May 16, 2012

(30) Foreign Application Priority Data
Sep. 29, 2009 (FR) 0956717

(51) Int. Cl. G06F 17/18

(52) U.S. Cl. 702/141

(57) ABSTRACT

Systems and methods for recognizing the gestures of an entity, notably a human being, and, optionally, for controlling an electrical or electronic system or apparatus, are discussed. The system uses sensors that measure signals, preferentially representative of inertial data about the movements of said entity, and implements a process for enriching a dictionary of said gestures to be recognized and a recognition algorithm, for recognition among the classes of gestures in said dictionary. The algorithm implemented is preferably of the dynamic time warping type. The system carries out preprocessing operations, such as the elimination of signals captured during periods of inactivity of the entity, subsampling of the signals, and normalization of the measurements by reduction, and preferentially uses, to classify the gestures, specific distance calculation modes and modes for merging or voting between the various measurements by the sensors.

### CROSS-REFERENCE TO RELATED APPLICATIONS

This application is the National Stage of International Application No. PCT/EP2010/064501, Sep. 29, 2010, which claims foreign priority to French application no. 0956717, filed on Sep. 29, 2009. The contents of both of these applications are incorporated herein by reference.

### BACKGROUND OF THE INVENTION

1. Field of the Invention

The present invention belongs to the field of gesture recognition systems. More precisely, the invention is applicable to the characterization of gestures, notably human gestures, in relation to a learning database comprising classes of gestures so as to be able to recognize said gestures reliably and, optionally, to use the results of said recognition to control one or more devices, notably electronic devices.

2. Description of the Related Art

A system for characterizing gestures normally comprises a number of position and/or orientation sensors for acquiring a plurality of signals representative of the gestures made by the person wearing said sensors. These sensors may for example be accelerometers, gyroscopes or even magnetometers. A signal processing module is normally provided for conditioning said signals. Another module then carries out a method of classifying the signals in order to recognize the gesture in the learning database by providing a recognition acceptance threshold. A number of classification methods can be used, notably those used in speech recognition, such as the following: HMM (Hidden Markov Modes); LTW (Linear Time Warping) and DTW (Dynamic Time Warping). A DTW gesture recognition method applied in a system for remotely controlling electronic apparatus (the XWand™ from Microsoft®) is disclosed in European patent application no. EP 1 335 338 and in the publication “Gesture Recognition Using The XWand” (D. Wilson, Carnegie Mellon University and A. Wilson, Microsoft Research, 2004). The degree of recognition cited by the latter publication, which is below 72%, is not acceptable for industrial applications, making this method unusable.

### SUMMARY OF THE INVENTION

The present invention solves this problem by providing both preprocessing and postprocessing procedures that significantly improve the degree of recognition.

For this purpose, embodiments of the present invention include a system for recognizing gestures of an entity, the system comprising a module for capturing signals generated by said movements of said entity, a module for storing data representative of signals which have been captured and organized in classes of gestures, a module for comparing at least some of the signals captured over a time window with said classes of stored signals, said system further comprising a module for preprocessing at least some of said signals captured over a time window and wherein said preprocessing comprises at least one of the functions chosen from the group comprising elimination by thresholding within said captured signals, to eliminate those corresponding to periods of inactivity, subsampling of the captured signals and normalization by reduction of said signals.

According to one embodiment of the invention, when the chosen function is a normalization, said captured signals are centered before reduction.

Advantageously, said module for capturing signals generated by said movements of said entity may comprise at least one sensor for inertial measurements along three axes.

Advantageously, said module for comparing the signals captured over a time window may perform said comparison by executing a dynamic time warp algorithm.

Advantageously, said storage module may comprise, for each signal class, a data vector representative of at least one signal distance measurement for the signals belonging to each class.

Advantageously, the data vector representative of at least one signal distance measurement for the signals belonging to each class may comprise, for each class of signals stored, at least one intraclass distance measurement and measurements of distances between said class and each of the other classes stored.

Advantageously, the intraclass distance measurement may be equal to the average of the pairwise distances between signals of the class, each distance between signals being representative of gestures belonging to the class being calculated as the minimum of the root mean square deviation between sequences of specimens of the signals on deformation paths of the DTW type.

Advantageously, the interclass distance measurement may be equal to the average of the pairwise distances between signals of the two classes, each distance between signals being representative of gestures belonging to a class being calculated as the minimum of the root mean square deviation between sequences of specimens of the signals on deformation paths of the DTW type.

Advantageously, said dynamic time warp algorithm may use a gesture recognition criterion represented by said signals captured over a time window based on a measurement of the distance of said signals captured over a time window with the vector representative of the classes of reference signals stored in said storage module.

Advantageously, said distance measurement may be normalized by an intraclass distance measurement.

Advantageously, said distance measurement may be carried out by calculating, using a DTW algorithm, an index of similarity between the at least one measurement signal and the reference signals along the minimum cost path through a matrix of Euclidean distances between the vector whose components are the measurements of the axes of the at least one sensor on the signal to be classified and the vector of the same components on the reference signal.

Advantageously, said distance measurement may be carried out by calculating, using a DTW algorithm, an index of similarity between the at least one measurement signal and the reference signals along the minimum cost path through a matrix whose elements are the derivatives of the scalar product of the measurement vector and the reference vector.

Advantageously, said module for capturing said signals may comprise at least two sensors.

Advantageously, the system of the invention may further include a module for merging the data coming from the comparison module for the at least two sensors.

Advantageously, the module for merging the data coming from the comparison module for the at least two sensors may be configured to perform a voting function between said data coming from the comparison module for the at least two sensors.

Advantageously, said distance measurement may be carried out by operations belonging to the group comprising: i) a calculation, using a DTW algorithm, of an index of similarity between the at least one measurement signal and the reference signals along the minimum cost path through a matrix of Euclidean distances between the vector whose components are the measurements of the axes of the at least two sensors on the signal to be classified and the vector of the same components on the reference signal, said index of similarity constituting the distance measurement; and ii) a calculation, using a DTW algorithm, for each sensor, of an index of similarity between the at least one measurement signal and the reference signals along the minimum cost path through a matrix of the Euclidean distances between the vector whose components are the measurements of the axes of one of the at least two sensors on the signal to be classified and the vector of the same components on the reference signal, followed by a calculation of the distance measurement by multiplying the indices of similarity delivered as output of the calculations on all the sensors.

Advantageously, said distance measurement may be carried out by calculating, for each sensor, an index of similarity between the at least one measurement signal and the reference signals along the minimum cost path through a matrix whose elements are the derivatives of the scalar product of the measurement vector and the reference vector, followed by a calculation of the distance measurement by multiplying the indices of similarity delivered as output of the calculations on all the sensors.

Advantageously, said distance measurement may be carried out by calculating, using a DTW algorithm, for each sensor, an index of similarity between the at least one measurement signal and the reference signals along the minimum cost path through a matrix comprising either of the Euclidean distances between the vector whose components are the measurements of the axes of one of the at least two sensors on the signal to be classified and the vector of the same components on the reference signal, or by the derivatives of the scalar product of the measurement vector and the reference vector, followed by a calculation of the distance measurement by multiplying the indices of similarity delivered as output of the calculations on all the sensors.

Advantageously, the preprocessing module may execute a thresholding elimination function within said captured signals to eliminate those corresponding to periods of inactivity by filtering out the variations in signals below a chosen threshold over a likewise chosen time window.

Advantageously, the preprocessing module may execute a subsampling function on the captured signals by decimating with a chosen reduction ratio of the captured signals followed by taking an average of the reduced signals over a sliding space or time window matched to the reduction ratio.

Advantageously, data representative of the decimation may be stored by the storage module and transmitted as input into the comparison module.

Advantageously, the preprocessing module may execute in succession an elimination function within said captured signals, to eliminate those corresponding to periods of inactivity, a subsampling function on the captured signals and a normalization function by a reduction of the captured signals.

Advantageously, at least some of the captured signals and of the outputs of the comparison module can be delivered as inputs to the storage module, to be processed therein, the results of said processing operations being taken into account by the current processing operations of the comparison module.

Advantageously, the system of the invention may further include, on the output side of the preprocessing module, a trend extraction module capable of initiating the execution of the comparison module.

Advantageously, said trend extraction module may initiate the execution of the comparison module when the variation of a characteristic quantity of one of the signals captured over a time window violates a predetermined threshold.

Advantageously, the system of the invention may further include, on the input side of the storage module, a class regrouping module, for grouping into K groups of classes representative of families of gestures.

Advantageously, initiating the comparison module may trigger the execution of a function of selection of that one of the K groups the compared signal of which is closest, followed by a dynamic time warp algorithm between said compared signal and the gestures of the said selected group.

Embodiments of the present invention also relate to a method of recognizing gestures of an entity, comprising a step of capturing signals generated by said movements of said entity with at least three degrees of freedom, a step of comparing at least some of the signals captured over a time window with classes of signals which have been stored and organized in classes representative of gestures of entities, said method further comprising, prior to the comparison step, a step of preprocessing at least some of said signals captured over a time window, wherein said preprocessing comprises at least one of the functions chosen from the group comprising elimination by thresholding within said captured signals, to eliminate those corresponding to periods of inactivity, subsampling of the captured signals and normalization by reduction of said signals.

Advantageously, said normalization may comprise centering before reduction of said captured signals.

Embodiments of the invention may be implemented without having recourse to external aids such as image or speech recognition (as is the case with the XWand™) and therefore does not require the use of complex data-merging algorithms and devices.

Embodiments of the invention also has the advantage of being able to use sensors that are small, lightweight, of low power consumption and inexpensive, such as MEMS (Microelectromechanical System) sensors.

The use of inertial and/or magnetic measurements also makes it possible to circumvent capture volume limits that characterize image processing devices in which capture is limited to the field of view of the cameras, the use, still possible, of steerable cameras introducing a much greater complexity of the system.

Furthermore, the capability provided by embodiments of the invention of adapting the processing to various classes of sensors and use scenarios, by optimizing the procedures for merging the various data, makes it possible for the system to be very versatile and therefore to have a very wide range of applications.

Finally, in certain embodiments of the invention, the captured gestures may be recognized by executing the comparison algorithm only when there is a significant variation of a movement signal and by organizing the gesture database into groups of classes.

These embodiments permit the recognition of long gestures or long sequences for which a preprocessing operation is used that decimates even further the signals representative of the captured gestures, using a trend extraction method, thus making it possible to reduce the processing time even more.

### BRIEF DESCRIPTION OF THE DRAWINGS

The invention will be better understood and its various features and advantages will become apparent from the following description of a number of illustrative examples and the appended figures thereof, in which:

FIG. 1 shows an example of a scenario in which the invention is used in one of its embodiments;

FIG. 2 is a diagram of the overall architecture of the system of the invention in one of its embodiments;

FIG. 3 is a general flowchart of the processing operations for implementing the invention in one of its embodiments;

FIG. 4 illustrates one of the steps of a preprocessing procedure in one of the embodiments of the invention;

FIG. 5 illustrates an example of a criterion for implementing a comparison processing operation carried out on signals representative of gestures by applying a DTW algorithm;

FIG. 6 illustrates the degree of recognition of an embodiment gesture recognition system according to a first decision criterion variant;

FIGS. 7A and 7B respectively illustrate the degree of recognition and the degree of false positives of a gesture recognition system of an embodiment of the invention according to a second decision criterion variant;

FIGS. 8A and 8B respectively illustrate the degree of recognition and the degree of false positives of a gesture recognition system of an embodiment of the invention according to a third and fourth decision criterion variant;

FIG. 9 is a flowchart of the processing operations applied in the case of a gesture recognition in certain embodiments of the invention using trend extraction and/or feature extraction;

FIG. 10 illustrates the principle of trend extraction in certain embodiments of the invention; and

FIG. 11 illustrates the principle of using a mobile center algorithm in certain embodiments of the invention.

### DETAILED DESCRIPTION OF THE PREFERRED EMBODIMENT

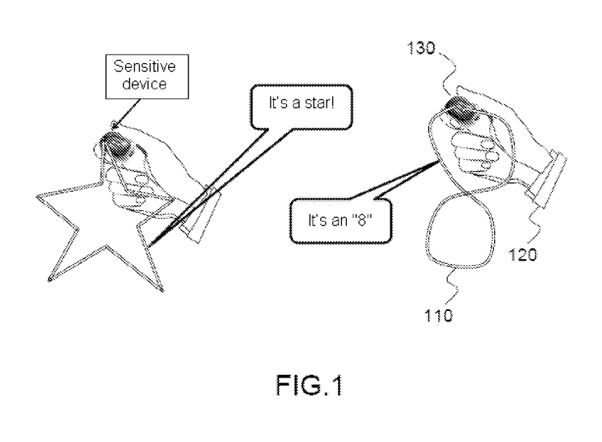

FIG. 1 shows an example of a scenario in which the invention is used in one of its embodiments.

The system of an embodiment of the invention relates to the field of gesture capture and recognition. This field is notably of interest to the general public for man-machine interaction applications or those based on gesture recognition (for example, multimedia system, interactive game consoles, universal remote control for electrical and/or electronic apparatus of all kinds at home, use of a mobile telephone as remote control, control of musical instruments, etc.). It may also relate to professional or semiprofessional applications, such as writing recognition or simulation for training, for sports, flying, or other activities.

The system of an embodiment of the invention preferably uses motion-sensitive sensors which are worn either directly on a person (on one or both of the wrists, on one or both of the ankles, on the torso, etc.) or in a device moved by the gesture of the person (3D mouse, remote control, telephone, toy, watch, accessories, garments, etc.). The description of the invention mentions mainly sensors of the MEMS type (gyroscopes and/or accelerometers) and magnetometers, but the principles of the invention may be generalized to other motion-sensitive measurements, such as image acquisition, possibly in the infrared, force or pressure measurements, measurements performed by photoelectric cells, telemetry measurements, radar or lidar measurements, etc. Preferably, however, the sensors used to provide signals are sufficiently representative of the gestures to be captured, in particular of the number of degrees of freedom that it is necessary to take into account in order to recognize them. It will be seen later in the description that by having sensor redundancy it is advantageously possible to increase substantially the recognition performance by a relevant combination of the measurements from the various sources.

To give an example, FIG. 1 shows a gesture 110 representative of an “8” produced by an entity 120, in this case a hand. This entity is instrumented with a device sensitive to the movements 130. The “8” may for example be the number of a television channel or the number of a game on a console. Objects may thus be commanded, by being called by one or more letters or numbers that represent said objects in a code specific to the application, and then one of the functions that said objects may execute may be called by another alphanumeric character of a second level of said code.

In the field of multimedia applications on a personal computer or on a room console, an embodiment of the invention applies in a product associated with a 3D mouse (i.e. held “in the air”) or with any other sensitive peripheral allowing interaction controlled by control software. It may for example be an AirMouse™ that comprises two gyroscopic sensors, each having a rotation axis. The gyroscopes used may be those of the Epson XV3500 brand. Their axes are orthogonal and deliver the angle of yaw (rotation about the axis parallel to the horizontal axis of a plane facing the AirMouse user) and the angle of pitch (rotation about an axis parallel to the vertical axis of a plane facing the AirMouse user). The instantaneous pitch and yaw velocities measured by the two gyroscope axes are transmitted to a microcontroller built into the body of the mouse and converted by said microcontroller into a displacement. This data, representative of the movement of a cursor on a screen facing the user is transmitted by radio to a computer or to an apparatus that controls the display of the moving cursor on the screen. The gestures performed by the hand holding the AirMouse take on an actuation meaning whenever they are recognized by the system. For example, a cross (or an “alpha” sign) is made to suppress an item on which the system focuses (“active” item in computer language).

In another field of application, such as in sports, it is possible to recognize and count certain technical gestures, such as a forehand or a backhand in tennis, for the purpose of statistical match analysis, for example. It is also possible to study the profile of a performed gesture relative to an ideal or model technical gesture and to analyze the differences (notably the gesture phase in which the gesture performed departs from the model), so as to target or identify the defect in the gesture (a jerk at the moment of striking the ball for example). In these applications, the sportsman will wear sensors of the MotionPod™ type at judiciously chosen locations. A MotionPod comprises a three-axis accelerometer, a three-axis magnetometer, a preprocessing capability for preshaping signals from the sensors, a radiofrequency transmission module for transmitting said signals to the processing module itself, and a battery. This movement sensor is called a “3A3M” sensor (having three accelerometer axes and three magnetometer axes). The accelerometers and magnetometers are commercial microsensors of small volume, low power consumption and low cost, for example a KXPA4 3628 three-channel accelerometer from Kionix™ and Honeywell™ magnetometers of HMC1041Z (1 vertical channel) and HMC1042L (2 horizontal channels) type. Other suppliers exist: Memsic™ or Asahi Kasei™ in the case of magnetometers and STMT™, Freescale™, and Analog Device™ in the case of accelerometers, to mention only a few. In a MotionPod, for the 6 signal channels, there is only analog filtering and then, after analog-digital (12 bit) conversion, the raw signals are transmitted by a radiofrequency protocol in the Bluetooth™ (2.4 GHz) band optimized for consumption in this type of application. The data therefore arrives raw at a controller, which can receive the data from a set of sensors. The data is read by the controller and acted upon by software. The sampling rate is adjustable. By default, the rate is set at 200 Hz. However, higher values (up to 3000 Hz, or even higher) may be envisaged, allowing greater precision in the detection of shocks for example.

An accelerometer of the abovementioned type is sensitive to the longitudinal displacements along its three axes, to the angular displacements (except about the direction of the Earth's gravitation field) and to the orientations with respect to a three-dimensional Cartesian reference frame. A set of magnetometers of the above type serves to measure the orientation of the sensor to which it is fixed relative to the Earth's magnetic field and therefore orientations with respect to the three reference frame axes (except about the direction of the Earth's magnetic field). The 3A3M combination delivers smoothed complementary movement information.

The same type of configuration can be used in another field of application, namely in video games. In this case, the gestures allow deeper immersion and very often require to be recognized as soon as possible. For example, a right hook in boxing will be recognized even before the end of the gesture: the game will rapidly trigger the action to be undertaken in the virtual world.

One version of the MotionPod™ also contains two microgyroscope components (having two rotation axes in the plane of the circuit and one rotation axis orthogonal to the plane of the circuit). The addition of this type of sensor provides a wealth of possibilities. It allows typical IMU (Inertial Measurement Unit) preprocessing, which makes it possible to deliver a dynamic angle measurement. The 3A3M3G combination (in which G stands for gyroscope) delivers smoothed complementary movement information, even for rapid movements or in the presence of ferrous metals that disturb the magnetic field. For this type of implementation, advantageous preprocessing consists in resolving the orientation of the sensor in order to estimate the movement acceleration and get back to the position by double integration. This position represents the trajectory of the gesture—data which is easier to classify.

In the world of mobile telephones, the gestures are relatively simpler, facilitating usage. It is a question of tapping in to the telephone's mechanism and of recognizing these signatures, or else of performing translational movements in all directions or else recognizing the gesture of picking up the telephone or putting it down. However, if the mobile telephone contains this type of sensor able to monitor pointing, the description of the operating modes is akin to that of the field of multimedia applications (see above) in which the mobile telephone is used in place of a remote control or a mouse.

It will therefore be seen that the range of possible applications for the system of the invention is very broad and that various sensors may be used. The invention makes it possible to adapt the processing to the sensors employed and to the use scenarios, taking into account the desired recognition precision.

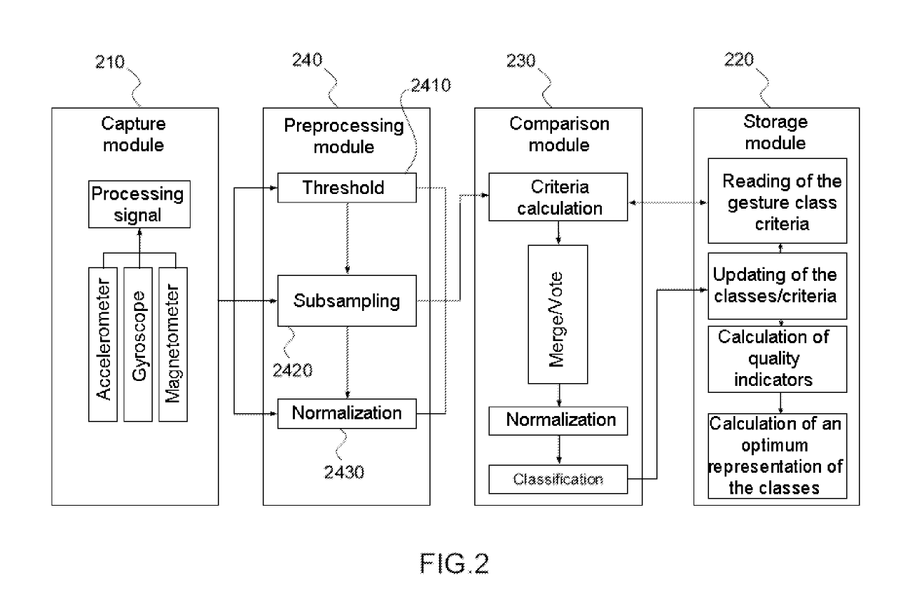

FIG. 2 is a diagram of the overall architecture of the system of the invention in one of the embodiments thereof.

A gesture recognition system according to an embodiment of the invention comprises:
a module 210 for capturing signals generated by movements of an entity bearing sensors;
a module 220 for storing precaptured signals organized into classes of gestures;
a module 230 for comparing at least some of the signals captured over a time window with said classes of signals stored; and
a module 240 for preprocessing at least some of said signals captured over a time window.

We have given above, as comments in FIG. 1, examples of embodiments relating to the module 210, which generally comprises at least one sensor device 130. Advantageously, the sensor devices 130 may be of the 3A3G (3-axis accelerometer and 3-axis gyroscope) type or 3A3M (3-axis accelerometer and 3-axis magnetometer) type or 3A3G3M (3-axis accelerometer, 3-axis gyroscope and 3-axis magnetometer) type. The signals will in general be transmitted to a controller by radio (Wi-Fi or Bluetooth link, with possible use of a specific application protocol layer optimized for transmitting signals captured by movement sensors).

The modules 220 and 230 are characteristic of the class of applications for recognition by classification to which the invention relates. Specifically, like speech or writing recognition, gesture recognition draws benefit from a learning stage, which makes it possible to create classes of signal waveforms representative of a given gesture. The broader the field of application and the more numerous the users, whose gestures are to be recognized, the more classification provides advantages in terms of recognition quality.

It will be possible to detect the occurrence of a gesture 120 performed by the entity 110 from a database of predetermined gestures. This database of predetermined reference gestures is called a “gesture dictionary” or storage module 220. The action of inputting a new gesture into the dictionary 220 is called “enrichment”. The action of recognizing whether or not a gesture performed appears in the dictionary 220 is called “recognition” if the gesture is present therein or “rejection” if the gesture is absent. The onboard sensors measure a signature representative of the gesture performed. The overall technical problem posed is a problem of recognition (or classification). This is a question of associating this measurement information received by the system with the class to which the gesture performed belongs. A class may include one or more executions of the gesture to be learnt. The executions in any one class may vary depending on the context or the user. When it is desired to produce a system required to classify, a number of specific technical problems may arise:
the relevance of the input data which, in order to be improved, may possibly require preprocessing;
the speed of execution of the gesture, which varies with each execution;
the recognition robustness, which makes it possible to ensure that a gesture appearing in the gesture dictionary is clearly recognized and belongs to the correct class (low probability of nondetection or high level of recognition) and to discard gestures that do not form part of the learned database (probability of a false alarm) and to minimize the number of gestures assigned to a wrong class (low level of false positives);
the response time of the system and the computational cost;
the number of gestures to be recognized and the number of executions of these gestures to be provided for enrichment;
the robustness for handling a number of users;
the capability of managing the variants of a given gesture (for example, a gesture of low amplitude and the same gesture of high amplitude, or a gesture made in a particular direction and the same gesture made in a different direction); and
the capability of managing the gesture recognition on the go, without having to indicate the instants of starting and/or ending the gesture.

The problem of recognizing a shape, which is formed in principle over an unknown period of time, has been studied since the start of speech recognition in which it is desired to recognize phonemes and pronounced words [see “Automatic speaker verification: A review” (A E Rosenberg, 1976) and “Fundamentals of Speech Recognition” (B-H Juang, 1993)]. Gesture recognition inherits the same problem: a given gesture may be performed at different rates and with different amplitudes. The processing solutions are based on methods for stretching and expanding the signals over time so as to make them coincide as close as possible to the learned shape. The DTW algorithm forms part of this processing class and was first applied for speech recognition [see “Performance tradeoffs in dynamic time warping algorithms for isolated word recognition” (C. Myers, L. Rabiner and A. Rosenberg, 1980)]. The possibility of recognizing gestures detected by sensors of the accelerometer type was also studied in the 1990s [see “Dynamic Gesture Recognition Using Neural Networks; A Fundament for Advanced Interaction Construction”, (K. Boehm, W. Broil and M. Sokolewicz, 1994)]. Combining with gyroscopes has also been studied a little later [see notably the patent EP 0 666 544 B1, “Gesture input method and apparatus” (published in August 1995 and granted in July 2002 to Canon); international patent application WO 2003-001340 A2, “Gesture recognition system and method” (published in January 2003 but abandoned without entering the national phase); the report entitled “Project EMMU: Emotional, Motional Measurement Unit” (CSIDC Seoul National Univ., Jun Keun Chang, 2003); the publication “Workshop on Sensing and Perception for Ubiquitous Computing” (part of UbiComp, 2001, September 2001); and also the patent and the publication by Microsoft that are mentioned in the introduction of the present description]. The Canon patent describes a device mainly worn on the hand, which device compares measured signals (difference between sensors) with reference signals (dictionary). This patent discloses neither particular comparison means nor preprocessing means. The publications and patents relating to Microsoft's XWand have studied the suitability of the DTW method for establishing the gesture recognition function. They describe the original use of the XWand for perception environments in home electronic applications (aiming of objects in 3D). The XWand is an electronic “magic wand” comprising accelerometers, magnetometers, gyroscopes, control buttons, a wireless transmitter, an infrared diode and a microcontroller. The Wilson publication explains that methods such as DTW may provide solutions for gesture recognition. The authors compare the performance of three particular algorithms (LTW, DTW and HMM). The results indicate that the most effective method is the HMM method with 90% recognition, as opposed to 72% in the case of DTW.

The objectives that the inventors set is to achieve, for games/multimedia applications, a gesture detection probability of 95% and a false positive level of 3%.

It will be seen later in the description that these objectives have been achieved, including with several users.

Furthermore, one of the advantages of the methods using a DTW algorithm, which may in certain applications make them preferable to HMM methods, is that they are “self-learning”, that is to say that it is sufficient, as a general rule, to enrich the gesture dictionary without it being necessary to adjust weightings. However, depending on the application, the use of DTW algorithms will consume more computing power than the use of HMM algorithms.

The precise operation according to the embodiment of the invention of the modules 220 and 230 will be explained in detail later in the description.

The module 240 comprises preprocessing functions that make it possible to prepare the captured signals in order to optimize recognition, said functions also being described in detail in the rest of the description.

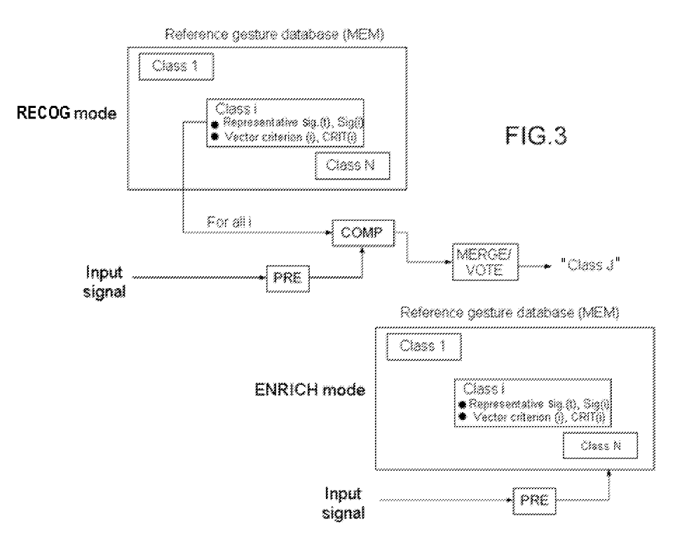

FIG. 3 is an overall flowchart for the processing operations implementing the invention in one of its embodiments.

The gesture recognition system of an embodiment of the invention may alternatively, or as required, enrich the database or recognize/reject a gesture. The user may specify if he is working in enrichment mode or in recognition mode. It is also possible, for certain gestures lying at the boundaries of neighboring classes, to envisage operating simultaneously in recognition mode and enrichment mode. In this case, it will be advantageous to provide an interface accessible to a user who is not an administrator of the system, so as to be able to easily confirm or reject an assignment to a class during the operational exploitation of the system.

In recognition mode RECOG, the complete solution is a sequence of processing operations made up of a number of function blocks:
a preprocessing module PRE, 240 acting on the input signals. This module may be configured in the same way for all the classes or may be configured specifically for one or more classes; and
a comparison module COMP, 230, for comparing the preprocessed input signals with reference signals that have undergone the same preprocessing operations. This module delivers an indicator representing the similarity between the signal representative of the gesture to be recognized and the signals representative of the reference gestures.

This comparison module comprises a MERGE block, which serves to select the best solution and/or reject a gesture that does not form part of the vocabulary of learnt gestures. The selection may be made for example by computing a selection function by optimizing a choice criterion or by voting between computed solutions as outputs of the various operating procedures of the available sensors.

In enrichment mode ENRICH, a system of an embodiment of the invention employs a sequence of processing operations that uses various functions:
that of the preprocessing module PRE, 240, carried out on the input signal to be stored; and
that of the storage module MEM, 220, in which the preprocessed signals SIG(i) and a criterion vector CRIT(i) associated with the class, i being the number of the class, are stored. There may be enrichment of the stored reference by a new class or enrichment of an existing class by a new signal.

To initialize the database of examples, it is desirable to introduce a first example of a first gesture in manual mode. The system may be operated in automatic or semi-automatic mode as soon as there is at least one example of a gesture in the database. The initial reject or accept criteria may be fixed at a judiciously chosen value, the enrichment mode allowing this value to be progressively adjusted.

The preprocessing module 240 may execute three signal preparation functions in the two operating modes, ENRICH and RECOG. Each of these preparation functions may or may not be implemented according to the context of use of the system. It is conceivable for one of these functions to be activated or deactivated automatically within certain operating ranges:
a function of eliminating the parts of signals that are not useful or of chopping the useful signal (the performance is advantageously enhanced by discarding the periods of inactivity before and after the actual gesture). The periods of inactivity may be identified by using the variations in the observed signal—if these variations are low enough over a sufficiently long time, this is considered to be a period of inactivity. There may be a kind of thresholding—this chopping may be carried out in line in order to detect the start and end of a gesture (if there are pauses between the gestures) and is carried out over a sliding window F:
   if var(signal)_{F}<Th, where Th is a threshold defined by the user, then the period is inactive and the signal over this period is eliminated;
   the preprocessing may also include a low-pass signal filter, such as a Butterworth filter or a sliding-average filter, thereby making it possible to eliminate the inopportune variations due to a deviation with respect to the normal gesture;
a function of subsampling the signals, optionally after the function of eliminating the parts of signals that are not useful, said subsampling function making it possible to reduce the processing time considerably and being able notably to take the form of a:
   regular decimation of the time signal (with low-pass prefiltering): in practice, since the capture systems that are used in one embodiment of the invention are sampled at 200 Hz, it is advantageous to use filter averaging over segments, for example 40 points, in order to obtain a final signal sampled in this case at 5 Hz, which is a frequency particularly well suited for the dynamics of human gestures. The averaged signal (centered on the window) is expressed as:

$${S}_{m} ( i ) = \frac{1}{2 N + 1} {\sum }_{k = - N}^{k = N} {S}_{m} ( i + k ) ;$$

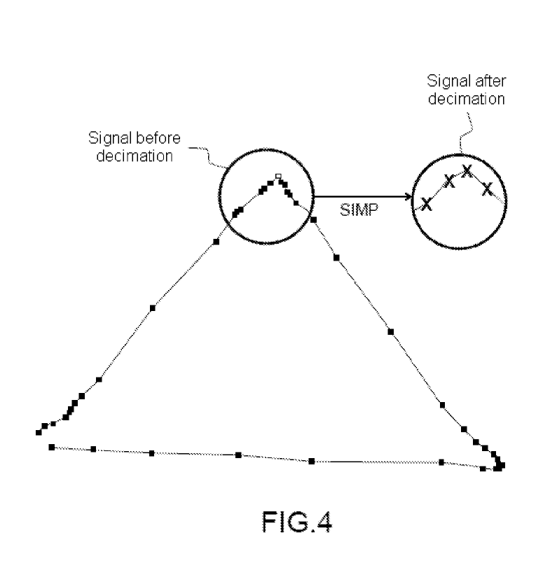

regular decimation of a spatial signal derived from the temporal signal, which will therefore be decimated irregularly, that is to say at a variable frequency as illustrated in FIG. 4. This function performs a simplification (SIMP) in order to adapt the signals to the behavior of a stretching algorithm of the DTW type, which simplification consists in advancing a window along the “trajectory” of the input signals (for example a trajectory in a 3-dimensional space if the system has a three-axis accelerometer for measuring signal). All the points contained in this adjustable window are replaced by just one point, at the barycenter (in terms of time and value) of the samples. The window is then moved along the trajectory in order to continue “cleaning” the density of points;
said decimation being followed either by sending the sequence of decimated points to the classification function of the comparison module 230 or by sending a sequence representative of the density of signals accompanied optionally by the sequence of decimated points (the close points found in this sliding window on the trajectory generate a specimen of the sequence of decimated points and the number of these points is a measure of the density of the signals (see FIG. 4), which may be a discriminating factor for the gesture to be recognized);
a signal normalization function (called normalization by reduction) which may optionally be carried out after the subsampling function. When it is carried out, this normalization function consists in dividing the signals, output by this subsampling function, by their energy (the energy of the signals being the mean of the squares of the signals). This normalization therefore makes it possible to overcome the dynamics of the signals, according to the following formula:

$${Out}_{reduced} ( i ) = \frac{Out ( i )}{\sqrt{\frac{1}{N} {\sum }_{k = 0}^{k = N} {[ Out ( k ) ]}^{2}}}$$

according to a variant, the normalization function may consist in centering and then reducing the signals output by the accelerometers, that is to say, for each signal, according to one embodiment of the invention, we subtract therefrom their mean value (calculated over the length of the complete signal representative of the gesture) and we divide the signals resulting from this first normalization by their standard deviation, to carry out a second normalization. These normalizations therefore allow identical gestures made at different rates to be homogenized according to the following formulae:

$${Out}_{centered} ( i ) = Out ( i ) - \frac{1}{N + 1} {\sum }_{k = 0}^{k = N} Out ( k ) - \\ {Out}_{reduced} ( i ) = \frac{{Out}_{centered} ( i )}{\sqrt{\frac{1}{N}} {\sum }_{k = 0}^{k = N} {[ Out ( k ) - \frac{1}{N + 1} {\sum }_{l = 0}^{l = N} Out ( l ) ]}^{2}} .$$

The storage module MEM, 220 manages the database of reference gestures, either upon adding gestures to the database or when it is desired to optimize the existing database.

In enrichment mode ENRICH, upon adding a gesture to an existing class i or upon creating a new class by adding one or more gestures representative of this new class, we update the vector CRIT(i) that contains notably, for each class i:
an intraclass distance equal to the mean of all the 2 to 2 distances of the gestures of said class i; and
a set of interclass distances, each distance between class i and class j being equal to the mean of all the distances between an element of class i and an element of class j.

The intraclass and interclass distances are calculated as indicated later in the description for the recognition mode RECOG.

The evolution of these criteria provides information about the quality of the new gesture or of the new class relative to the existing reference gesture database. If the intraclass distance increases too much while at the same time the interclass distances become too small, it is possible according to one embodiment of the invention to inform the user that the reference gesture database has become degraded.

According to one embodiment of the invention, if it is desired to optimize the existing database, in the case in which there are many signals per class, it is possible to reduce the number of these signals by choosing optimal representatives:
either we calculate one or more “average” representatives that correspond to the centers of the classes. The distance of a new example relative to the average example of class i optionally divided by the associated intraclass distance and contained in CRIT(i) will give a relevant indicator of its appearance in class i. If several average representatives are calculated, these may be advantageously chosen to represent various ways of performing the same gesture, notably if the system is intended to be used by several users;
or we calculate “boundary” representatives that better define the boundaries between the classes. A new element will then be associated with the class of the zone in which it is found. This method is suitable when the database of examples is very substantial and when the boundaries between the classes are complex.

In recognition mode RECOG, the comparison module 220 executes the functions that are described below.

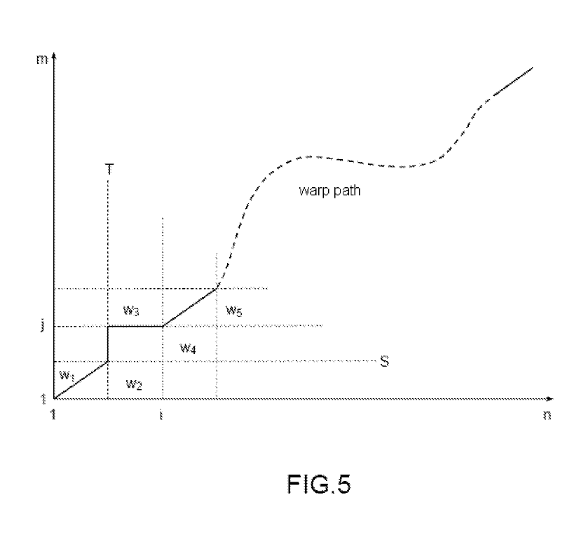

A comparison function COMP delivers a cost vector between the gesture to be classified and the signals of the reference gesture database. The costs are obtained by minimizing distances between two signals determined by the DTW algorithm and deliver the root mean square error or the distance, or the cost between the two compared signals, according to one of a number of conventional formulae that are indicated below when commenting on FIG. 5. The nature of this cost may vary depending on the sensors at our disposal, on the processing operations of the MERGE block, which are actually used according to the embodiment of the invention chosen, and on the application and the performance levels (recognition level/false positive level) to be given preference:
if we have only one operating procedure (with three-axis accelerometers or three-axis gyroscopes), we can calculate the cost between the three-axis signal to be classified and one of the signals from the reference gesture database: this cost involves Euclidean distances in 3 dimensions and thus makes it possible to work only on a distance matrix, thereby advantageously reducing the processing time (in comparison with the calculation of a cost per sensor channel, which increases the number of operations);
if we have access to two operating procedures, we can then:
   calculate the DTW cost of the signal in six dimensions (with a vector containing the information from the three axes of the accelerometer concatenated with the information from the three axes of the gyroscope);
   calculate a merged cost: our final cost is then the product of the two costs (one cost per operating procedure). This option makes it possible to advantageously profit from the complementary characteristics of each capture procedure and to combine them;
   to deliver to the MERGE block the pair of costs (accelerometer cost and gyroscope cost);
   to calculate a cost favoring one of the procedures. For example, the DTW path is calculated for one of the operating procedures (the most relevant one), the cost of the other procedure being calculated over this path (to reinforce the cost of the first procedure, or not). It is therefore possible, as previously, to deliver the product of the costs or the pair of costs.

Combining a third (or a fourth, etc.) operating procedure may be implemented in the same way: the techniques described above can be generalized to more than two operating procedures. If there are N signals delivered by M operating procedures (in the 3A3M3G case, this makes nine signals for three operating procedures), it is possible:
to calculate the DTW cost of the signal in N dimensions;
to calculate a merged cost: our final cost is then the product of the M costs (one cost per procedure): this option makes it possible to advantageously profit from the complementary characteristics of each capture procedure and to combine them;
to deliver the set of M costs to the MERGE block;
to calculate a cost favoring one of the operating procedures. For example, the DTW path is calculated for one of the procedures (the most relevant one), the cost of the other procedure being calculated over this path (to reinforce the cost of the first procedure, or not). It is then possible, as previously, to deliver the product of the costs or the pair of costs.

An optional postprocessing operation consists in normalizing the costs obtained as a function of the class criteria and is defined in the following manner: for calculating the cost between the gesture to be classified and a class i, we define the relative cost as the ratio of the previously calculated absolute cost to the intraclass distance of the class i (available in the vector CRIT(i)). Thus, this cost takes into account the geometrical characteristics of the classes (their spread and the distribution of their elements).

To factor out the orientation of the sensor with respect to the reference field (with respect to North in the case of magnetometers and with respect to the vertical in the case of accelerometers if the individual accelerations are small or if they have the same orientation within the general reference frame), it is possible to choose a particular distance that corresponds to the derivative of the scalar product of the two signals to be compared.

A MERGE or classification function delivers the classification decision for the gesture tested. An embodiment of our decision algorithm is based solely on the class of the nearest neighbor detected (the nearest neighbor being that which delivers the lowest cost). A variant is to choose the class of the K nearest neighbors, if several examples of each class are provided and stored in the storage module MEM, this having an unfavorable impact on the computing time in the DTW case. Several embodiments are possible depending on the configuration variants explained above in the case of the COMP block:
if we have scalar costs (cost of the accelerometer alone, cost of the gyroscope alone, or a merged cost), we then have a nearest neighbor:
   either we decide to assign the tested gesture to the class of the nearest neighbor whatever the value of the optimal cost—there is therefore no reject class. This allows us to have a maximal level of recognition, but a complementary level of false alarms;
   or we put into place a decision threshold: above this threshold, we assign the gesture to a reject class; below this threshold, the gesture is assigned to the class of the nearest neighbor. To regulate the threshold, it is then judicious to use the relative costs explained above, and we are able to optimize this threshold value according to the desired compromise between level of recognition and level of false alarms; and
if we have pairs of costs, we have one closer class per cost and we then compare the classes obtained: if these are the same classes, we assign the gesture to this class, otherwise we place the gesture in a reject class. This method makes it possible to obtain a reject class without threshold parameter management.

FIG. 4 illustrates one of the steps of a preprocessing procedure in one of the embodiments of the invention.

This aspect of the preprocessing, relating to the subsampling involving a simplification function SIMP, implemented in one embodiment of the invention, has already been commented upon and explained in a prior passage of the description.

FIG. 5 illustrates the implementation of a processing operation to compare representative signals of gestures by applying a DTW algorithm.

The costs or distances between samples of signals can be calculated in the manner that will be explained below:

Let S and T be two temporal sequences of signal samples, S being for example a measurement signal and T a reference signal:

S=s₁,s₂, . . . ,sᵢ, . . . ,sₙ

T=t₁,t₂, . . . ,tⱼ, . . . tₘ.

By fixing the boundary conditions for each sample (coincidence of the start dates and stop dates), the sequences S and T may be arranged to form an n by m grid in which each point (i, j) in the grid corresponds to a pair (sᵢ, tⱼ). The grid is represented in FIG. 5. A function w is defined over the field of the grid in order to transform the samples of the measurement signal over the time scale of the reference signal. Several functions w may be defined. Examples will be found notably in “Minimum Prediction Residual Principle Applied to Speech Recognition”—(Fumitada Ikatura, IEEE Transactions on Acoustics, Speech and Signal Processing, February 1975) and “Considerations in Dynamic Time Warping Algorithms for Discrete Word Recognition”—(L. R. Rabiner, A. E. Rosenberg and S. Levinson, IEEE Transactions on Acoustics, Speech and Signal Processing, December 1978). A third sequence W/may thus be defined as:

W=w(s₁),w(s₂), . . . ,w(sₖ), . . . w(sₚ).

This involves finding the path formed by the pairs (w(sᵢ), tⱼ) that maximizes a similarity indicator or minimizes the distance between the two samples.

To formulate the minimization problem, it is possible to use a number of formulae for calculating distance, either absolute value of the distance between the points of the sequences S and T, or the square of the distance between said points:

δ(i,j)=|sᵢ−tⱼ|.

or δ(i,j)=(sᵢ−tⱼ)².

As will be seen in the rest of the description, it is also possible to define other distance measurements. The formula to be minimized is in all cases:

$$DTW ( S , T ) = {min}_{W} [ {\sum }_{k = 1}^{p} δ ( w ( {s}_{k} ) , {t}_{k} ) ] .$$

In the context of the invention, the set of values δ(sᵢ,tⱼ) is called the matrix of the distances of the DTW algorithm and the set of values ( w̅)(sₖ),tₖ) corresponding to the DTW(S,T) minimum is called the minimum cost path through the distance matrix.

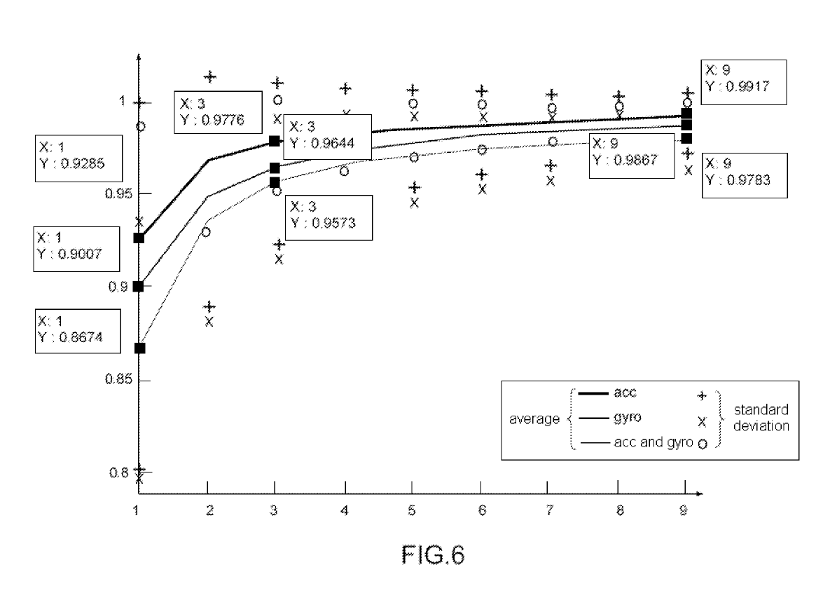

FIG. 6 illustrates the level of recognition of a gesture recognition system of an embodiment of the invention according to a first decision criterion variant.

In this illustrative example, the reference gesture database comprises gestures representative of numbers. There are six different users. The absolute cost defined above in the description is used as indicator of the distance between signals. The curves in FIG. 6 show the level of recognition plotted on the y-axis as a function of the number of measurements in each class plotted on the x-axis. The three curves are, respectively:
the curve at the bottom: the case in which only the gyroscope measurements are used;
the curve in the middle: the case in which only the accelerometer measurements are used; and
the curve at the top: the case in which the measurements from both sensors are used.

By merging the sensors it is possible for the level of recognition to be modestly improved.

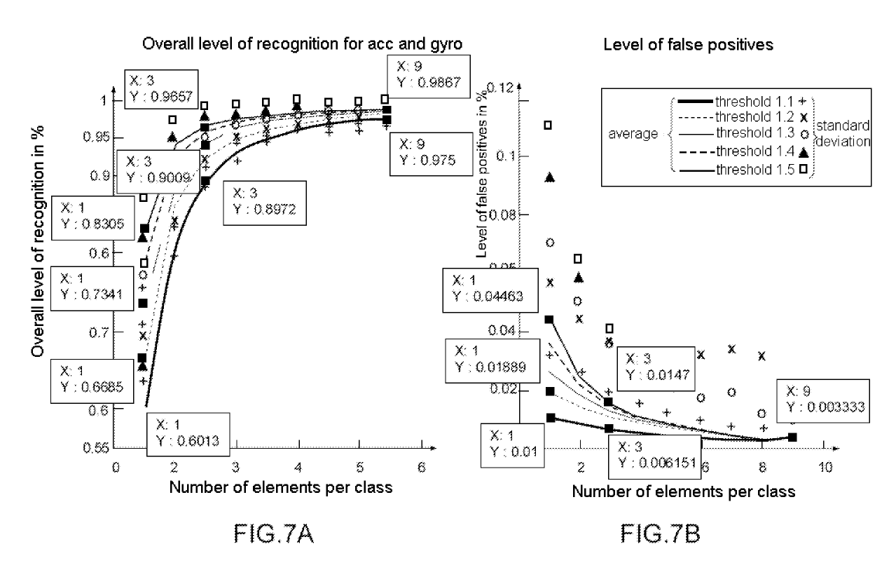

FIGS. 7A and 7B respectively illustrate the level of recognition and the level of false positives of a gesture recognition system of an embodiment of the invention according to a second decision criterion variant.

In this illustrative example, the reference gesture database also includes gestures representative of numbers and again there are six different users. This time, the relative cost defined above in the description is used as indicator of the distance between signals. The curves of FIGS. 7A and 7B, plotted on the y-axis, represent respectively the level of recognition and the level of false positives as a function of the number of measurements in each class plotted on the x-axis. The various curves in each figure represent measurements with rejection thresholds (from the bottom up in FIG. 7A and from the top down in FIG. 7B) that vary from 1.1 to 1.5 in steps of 0.1 (i.e. if the relative cost of the instance relative to the class is greater than K, the instance does not belong to the class.

The standard deviations are small and the performance levels are similar, thereby showing that the recognition system has good robustness for different users. The deviations between the curves for various thresholds show that if it is desired to reduce the number of errors (FIG. 7B) it is necessary to take a reliable threshold. However, there will also be a lower decision level too (FIG. 7A). This adjustment may be useful in enrichment mode: when no decision can be taken, the user is requested to enter the number of the class manually in order to enrich the database. It may also be beneficial, when it is preferred not to perform the action rather than performing a false action (for example if a gesture serves to identify the signature of a person, it is better to make the person sign once again rather than opening the application without being sure that this is indeed the right person).

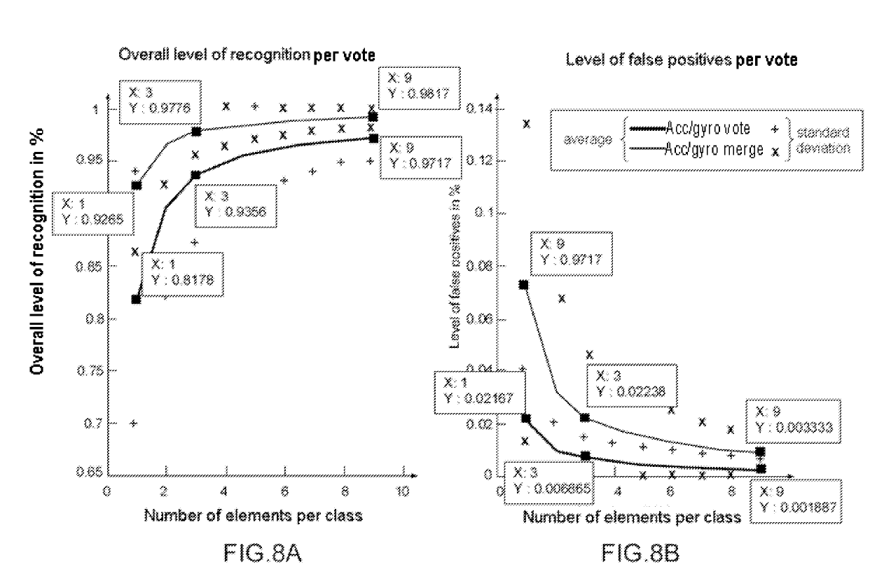

FIGS. 8A and 8B respectively illustrate the level of recognition and the level of false positives of a gesture recognition system of an embodiment of the invention according to third and fourth decision criterion variants.

In this illustrative example, the reference gesture database also comprises gestures representative of numbers and there are also six different users. This time, on the one hand, the data from two sensors are merged (top curve in FIG. 8A and bottom curve in FIG. 8B) and, on the other hand, a vote between sensors is used (bottom curve in FIG. 8A and top curve in FIG. 8B). It may be seen that the vote improves the level of false positives but degrades the level of recognition, thereby showing that the vote is more “severe” than the merge under the conditions in which these two operating procedures are carried out.

These examples illustrate the benefit of providing a number of embodiments depending on the use scenarios of the invention and on the type of privileged performance. These various embodiments may cohabit in one and the same system and be activated by software parameterizing according to the use requirements at a given moment.

In various embodiments, the invention may be implemented without any difficulty on a commercial computer to which will be connected a module for capturing the movement signals, normally providing the means for conditioning and transmitting said signals to the computer. The microprocessor of the central processing unit of an office PC is sufficient to implement the invention. The software operating the algorithms described above may be incorporated into an applicative software package comprising moreover:
libraries for controlling the low-level functions that perform the capture, conditioning and transmission of the signals from the movement sensors; and
modules for controlling functions (automatic character recognition) and modules for controlling electronic equipment, sets of musical instruments, sports training simulation, games, etc.

Of course the design of the central processing unit will determine to a large extent the performance of the system. The design must be chosen according to the expected performance at the applicative level. In the case of a very high performance constraint in terms of processing time, it may be envisaged to parallel the processing operations according to operating procedures known to those skilled in the art. The choice of target processor and language will depend to a great extent on this performance requirement and on the cost constraints.

It is also conceivable, for a limited number of gestures with a low degree of ambiguity, for the recognition algorithms to be incorporated in the entity wearing the sensors, or the processing operations being carried out locally.

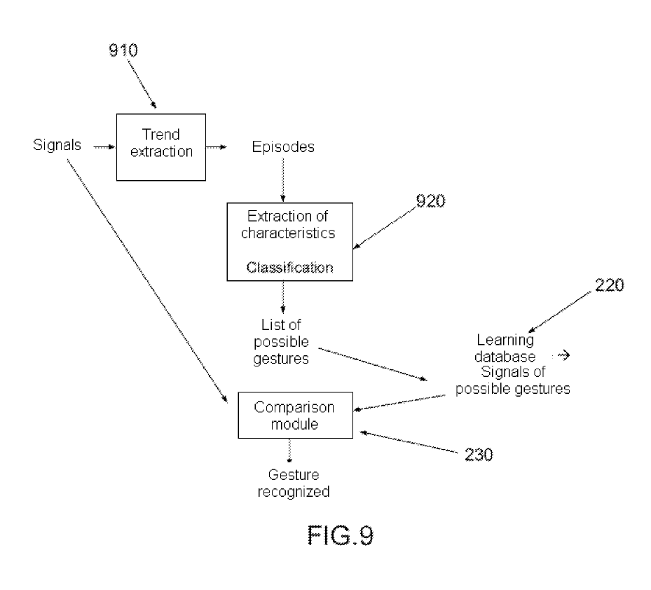

FIG. 9 is a flowchart for the processing operations applied in the case of gesture recognition in certain embodiments of the invention using trend extraction and/or extraction with characteristics.

In certain situations in which the gestures have to be recognized, notably for controlling devices, it is important to carry out the recognition in a short time. The execution of an algorithm for comparison with classes of gestures must therefore be optimized. One way of carrying out this optimization is described in FIG. 9. The objective of a first processing step is to avoid executing the algorithm when nonsignificant gestures are present.

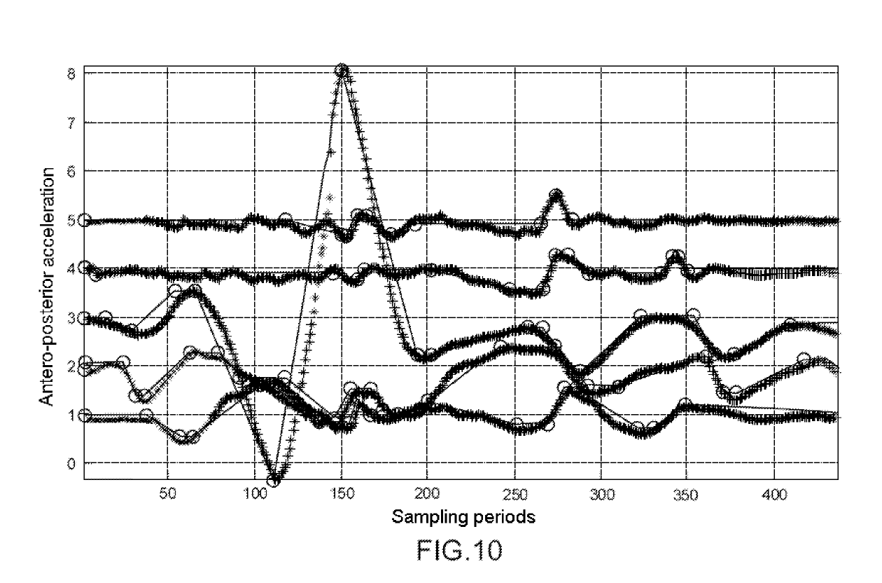

This objective is achieved notably by analyzing the successive temporal episodes and executing the algorithm of the comparison module 230 only when these episodes include a variation in the signal parameters which is considered to be characteristic of a meaningful gesture. A trend extraction module 910 is inserted between the preprocessing module 210 and the comparison module 230 in order to carry out this processing step. Its operation is described in the rest of the description in relation to FIG. 10.

The trend extraction module may be placed before the preprocessing module 210 so as to decimate the signals representative of the gestures before applying the chosen preprocessing operation(s) thereto.

Furthermore, to speed up the execution of the comparison module, it is advantageous to group the classes of the reference gesture dictionary using a grouping algorithm which may be of the mobile center algorithm or k-means algorithm type. Algorithms of this type group the classes into clusters, a characteristic quantity of which is an average value of the characteristic quantities of the grouped classes. A person skilled in the art of classification techniques knows how to carry out this type of grouping and to choose the characteristic quantity in order for the clusters to be appropriate to the application.

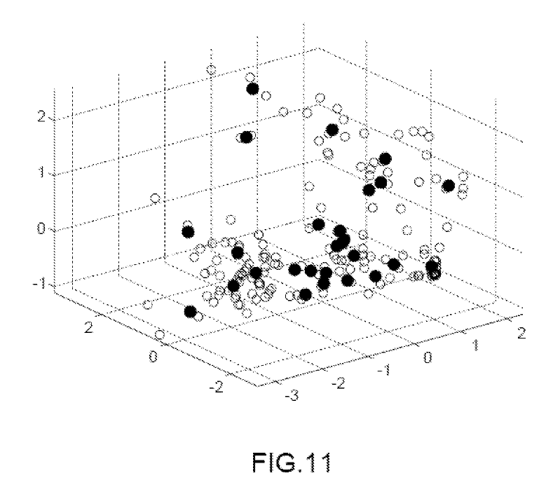

A class grouping module 920 is inserted for this purpose in an embodiment system of the invention. Said module also makes it possible to make a first comparison of the signals representative of the analyzed gestures with said clusters by calculating a Euclidean distance of the characteristic quantity of the cluster and at the same quantity in the analyzed signal. The operation of this module is described in the rest of the description in relation to FIG. 11.

FIG. 10 illustrates the principle of trend extraction in certain embodiments of the invention.

The trend extraction algorithm of the module 910 extracts, from a signal, a sequence of temporal episodes characterized by a start instant and a stop instant, the value of the signal at the start and at the end of the episode and symbolic information about the behavior (increasing, decreasing or steady) over time. When the application uses a number of accelerometers distributed over the entity whose gestures it is desired to recognize, the trend extraction may be applied on all the acceleration signals coming from sensors that measure the movements in the same direction. Each time that a new episode is detected in the trend of one of these signals, the analysis by the comparison algorithm, for example of the DTW type, is carried out on all said signals over a time window of duration D prior to detecting a new episode. This makes it possible to initiate the comparison analysis only when significant variations in one of said acceleration signals are detected.

A trend extraction algorithm of the type of that used for implementing an embodiment of the present invention is described in a different application context in the following publications: S. Charbonnier “On Line Extraction of Temporal Episodes from ICU High-Frequency Data: a visual support for signal interpretation”, Computer Methods and Programs in Biomedicine, 78, 115-132, 05; and S. Charbonnier, C. Garcia-Beltan, C. Cadet and S. Gentil “Trends extraction and analysis for complex system monitoring and decision support”, Engineering Applications of Artificial Intelligence vol. 18, No. 1, pp 21-36, 05.

This trend extraction algorithm extracts a succession of temporal episodes defined by: {primitive, [td, tf[, [yd, yf[}. This primitive may be steady, increasing or decreasing: [td, tf[expresses the time interval during which the time variation of the signal follows the primitive, these values corresponding to instants when a change occurs in the behavior of the signal and [yd, yf[expresses the values of the signal at the start and at the end of the episode, said values corresponding to the points where there is a change in the value of the signal and notably to the extrema.

FIG. 10 shows five acceleration signals recorded during a gesture (successions of approximately aligned crosses) and the corresponding trend extracted (solid curves connecting the circles). In this example, the entity is instrumented with five accelerometer axes that are substantially collinear in a front-rear or antero-posterior direction.

The trend extraction algorithm is set by three parameters. The values of these parameters are identical whatever the acceleration signal. One of the setting parameters serves to define the level above which a variation in the signal is significant. This is denoted by “threshold_variation”. In an illustrative example for an application to detect gestures in boxing, the algorithm is set so that only the amplitude variations greater than 0.6 are detected. The trend is not extracted with great precision, but this does make it possible not to detect the low-amplitude variations and thus not to trigger gesture detection too often.

FIG. 11 illustrates the principle of using a mobile center algorithm in certain embodiments of the invention. This figure represents the database of reference gestures (empty circles) and the cores of clusters (filled circles) formed by a mobile center algorithm in the space of the first three principal components thereof. The characteristics of the signal waveform that are extracted from the trend are delivered to a classification algorithm (mobile center algorithm) that determines the probable gestures made. The comparison algorithm (for example a DTW algorithm) is then used to determine which gesture was made by comparing the signals of probable gestures from the learning database with the measured signal. The advantage of the classification is that it reduces the number of gestures present in the learning database to be compared with the current gesture.

The principle of the method is described by the pseudo code below: Let S be the signal to be analyzed, which contains the five antero-posterior accelerations (in this example, the entity is instrumented with five accelerometer axes substantially collinear in a front-rear or antero-posterior direction) and let X(j).App be a file of the database containing an example of antero-posterior acceleration signals recorded during a gesture.

To carry out the learning operation:
extraction of the characteristics of the files X(j).App
application of a mobile center algorithm, to obtain K cores. Associated with each core is a list of possible gestures.

To detect gestures:

at each sampling period and for each acceleration signal:

extraction of the trend

if a new episode is detected,

set the “gesture to be analyzed” flag to 1

End If

End For
if gesture to be analyzed = 1:

for each acceleration signal,

extraction of the characteristics over a window D prior to
detection of the episode

End For
- calculation of the Euclidean distance between the reduced
centered characteristics extracted and the K cores
- selection of the closest core, to propose a list of possible
gestures. (If the distance to the closet core is greater than a
threshold distance, decision = 0)
- calculation of the DTW distance between the signal S and the
examples X(j).App corresponding to the list of possible
gestures.
If the distance is greater than a rejection threshold,

Decision = 0

otherwise

Decision = k, where k is the number of the gesture

associated with the file having the shortest DTW distance
End If

Set the “gesture to be analyzed” flag to 0
End If

End For

Advantageously, the DTW distance between the signal S and the examples X(j).App is calculated from the averaged, subsampled, signal, by increments of five sampling periods.

To prevent two decisions being made at two instants that are too close together, a latency time may be introduced. A decision is taken if a new episode is detected on one of the acceleration signals and if the time after the preceding decision is greater than a minimum time (latency time). The latency time may vary between 50 and 100 sampling periods, i.e. between 0.25 and 0.5 seconds, the sampling here being at 200 Hz. The latency time is introduced so as to mitigate the fact that the algorithm extracts the trend in line on one variable without taking into account the behavior of the other variables: the trend extraction is not synchronized. Thus, when two signals are correlated, the algorithm can detect a new episode on a first signal and shortly afterwards an episode on the second signal, which corresponds in fact to the same phenomenon. By introducing the latency time it is possible to avoid a second extraction.

A method according to an embodiment of the invention therefore makes it possible to reduce the number of calls on the comparison function (for example of the DTW type):
by calling on it only when a significant change in the temporal behavior of the signal is detected and
by reducing the number of examples of gestures in the learning database to be compared with the signals.

The examples described above have been given by way of illustration of embodiments of the invention, but they do not in any way limit the field of the invention which is defined by the following claims.

1-29. (canceled)

30. A system for recognizing gestures of an entity, comprising a module for capturing signals generated by said movements of said entity, a module for storing data representative of signals which have been captured and organized in classes of gestures, a module for comparing at least some of the signals captured over a time window with said classes of stored signals, said system further comprising a module for preprocessing at least some of said signals captured over a time window wherein said preprocessing comprises at least one of the functions chosen from the group comprising elimination by thresholding within said captured signals of those corresponding to periods of inactivity, subsampling of the captured signals and normalization by reduction of said signals.

31. The gesture recognition system of claim 30, wherein the normalization comprises centering before reduction of said captured signals.

32. The gesture recognition system of claim 30, wherein said module for capturing signals generated by said movements of said entity comprises at least one sensor for inertial measurements along three axes.

33. The gesture recognition system of claim 30, wherein said module for comparing the signals captured over a time window performs said comparison by executing a dynamic time warp algorithm.

34. The gesture recognition system of claim 33, wherein said storage module comprises, for each signal class, a data vector representative of at least one signal distance measurement for the signals belonging to each class.

35. The gesture recognition system of claim 34, wherein the data vector representative of at least one signal distance measurement for the signals belonging to each class comprises, for each class of signals stored, at least one intraclass distance measurement and measurements of distances between said class and each of the other classes stored.

36. The gesture recognition system of claim 35, wherein the intraclass distance measurement is equal to the average of the pairwise distances between signals of the two classes, each distance between signals representative of gestures belonging to a class being calculated as the minimum of the root mean square deviation between sequences of samples of the signals on deformation paths of a DTW type.

37. The gesture recognition system of claim 35, wherein the interclass distance measurement is equal to the average of the pairwise distances between signals of the two classes, each distance between signals representative of gestures belonging to a class being calculated as the minimum of the root mean square deviation between sequences of samples of the signals on deformation paths of a DTW type.

38. The gesture recognition system of claim 33, wherein said dynamic time warp algorithm uses a gesture recognition criterion represented by said signals captured over a time window based on a measurement of the distance of said signals captured over a time window with the vector representative of the classes of reference signals stored in said storage module.

39. The gesture recognition system of claim 38, wherein said distance measurement is normalized by an intraclass distance measurement.

40. The gesture recognition system of claim 38, wherein said distance measurement is carried out by calculating, using a DTW algorithm, an index of similarity between the at least one measurement signal and the reference signals along the minimum cost path along the elements of a matrix of Euclidean distances between the vector whose components are the measurements of the axes of the at least one sensor on the signal to be classified and the vector of the same components on the reference signal.

41. The gesture recognition system of claim 38, wherein said distance measurement is carried out by calculating, using a DTW algorithm, an index of similarity between the at least one measurement signal and the reference signals along the minimum cost path along the elements of a matrix whose elements are the derivatives of the scalar product of the measurement vector and the reference vector.

42. The gesture recognition system of claim 38, wherein said module for capturing said signals comprises at least two sensors.

43. The gesture recognition system of claim 42, further comprising a module for merging the data coming from the comparison module for the at least two sensors.

44. The gesture recognition system of claim 43, wherein the module for merging the data coming from the comparison module for the at least two sensors is capable of performing a voting function between said data coming from the comparison module for the at least two sensors.

45. The gesture recognition system of claim 44, wherein said distance measurement is carried out by operations belonging to the group comprising: i) a calculation, using a DTW algorithm, of an index of similarity between the at least one measurement signal and the reference signals along the minimum cost path along the elements of a matrix of Euclidean distances between the vector whose components are the measurements of the axes of the at least two sensors on the signal to be classified and the vector of the same components on the reference signal, said index of similarity constituting the distance measurement; and ii) a calculation, using a DTW algorithm, for each sensor, of an index of similarity between the at least one measurement signal and the reference signals along the minimum cost path through a matrix of the Euclidean distances between the vector whose components are the measurements of the axes of one of the at least two sensors on the signal to be classified and the vector of the same components on the reference signal, followed by a calculation of the distance measurement by multiplying the indices of similarity delivered as output of the calculations on all the sensors.

46. The gesture recognition system of claim 43, wherein said distance measurement is carried out by calculating, for each sensor, an index of similarity between the at least one measurement signal and the reference signals along the minimum cost path along the elements of a matrix whose elements are the derivatives of the scalar product of the measurement vector and the reference vector, followed by a calculation of the distance measurement by multiplying the indices of similarity delivered as output of the calculations on all the sensors.

47. The gesture recognition system of claim 43, wherein said distance measurement is carried out by calculating, using a DTW algorithm, for each sensor, an index of similarity between the at least one measurement signal and the reference signals along the minimum cost path along the elements of a matrix consisting either of the Euclidean distances between the vector whose components are the measurements of the axes of one of the at least two sensors on the signal to be classified and the vector of the same components on the reference signal, or by the derivatives of the scalar product of the measurement vector and the reference vector, followed by a calculation of the distance measurement by multiplying the indices of similarity delivered as output of the calculations on all the sensors.

48. The gesture recognition system of claim 30, wherein the preprocessing module executes a thresholding elimination function within said captured signals to eliminate those corresponding to periods of inactivity by filtering out the variations in signals below a chosen threshold over a likewise chosen time window.

49. The gesture recognition system of claim 30, wherein the preprocessing module executes a subsampling function on the captured signals by decimating with a chosen reduction ratio of the captured signals followed by taking an average of the reduced signals over a sliding space or time window matched to the reduction ratio.

50. The gesture recognition of claim 49, wherein data representative of the decimation are stored by the storage module and transmitted as input into the comparison module.

51. The gesture recognition system of claim 30, wherein the preprocessing module executes in succession an elimination function within said captured signals, to eliminate those corresponding to periods of inactivity, a subsampling function on the captured signals and a normalization function by a reduction of the captured signals.

52. The gesture recognition system of claim 30, wherein at least some of the captured signals and of the outputs of the comparison module can be delivered as inputs to the storage module, to be processed therein, the results of said processing operations being taken into account by the current processing operations of the comparison module.

53. The gesture recognition system of claim 30, further comprising, on the output side of the preprocessing module, a trend extraction module capable of initiating the execution of the comparison module.

54. The gesture recognition system of claim 53, wherein said trend extraction module initiates the execution of the comparison module when the variation of a characteristic quantity of one of the signals captured over a time window violates a predetermined threshold.

55. The gesture recognition system of claim 30, further comprising, on the input side of the storage module, a class regrouping module, for grouping into K groups of classes representative of families of gestures.

56. The gesture recognition system of claim 54, wherein initiating the comparison module triggers the execution of a function of selection of that one of the K groups the compared signal of which is closest, followed by a dynamic time warp algorithm between said compared signal and the gestures of the said selected group.

57. A method of recognizing gestures of an entity, comprising a step of capturing signals generated by said movements of said entity with at least three degrees of freedom, a step of comparing at least some of the signals captured over a time window with classes of signals which have been stored and organized in classes representative of gestures of entities, said method further comprising, prior to the comparison step, a step of preprocessing at least some of said signals captured over a time window, wherein said preprocessing comprises at least one of the functions chosen from the group comprising elimination by thresholding within said captured signals, to eliminate those corresponding to periods of inactivity, subsampling of the captured signals and normalization by reduction of said signals.

58. The method of recognizing gestures of an entity of claim 57, wherein said normalization comprises centering before reduction of said captured signals.
